(19) United States
(12) Patent Application Publication
(10) Pub. No.: US 2017/0000595 A1
(43) Pub. Date: Jan. 5, 2017

(54) HORSE BANDAGE

(71) Applicant: TOM-JEFF MANUFACTURES, INC., Taoyuan City (TW)

(72) Inventor: Jien-Liang Chen, Taoyuan City (TW)

(21) Appl. No.: 14/788,796

(22) Filed: Jul. 1, 2015

(51) Int. Cl. A61D 9/00

(52) U.S. Cl. CPC A61D 9/00

(57) ABSTRACT

The horse bandage contains an elongated main piece, a first fastening element configured at a first end of the main piece, and covering the first end's two major sides, a second fastening element configured at a second end of the main piece covering the second end's two major sides, a third fastening element configured on a major side of the main piece adjacent to the first fastening element, a fourth fastening element configured on a major side of the main piece adjacent to the second fastening element; and a bridge element to be positioned between and joined to the first and third fastening elements, or between and to the second and fourth elements. The horse bandage can be directly applied to a horse leg from a roller of the horse bandage, and re-collected into a roller as the horse bandage is simultaneously unwrapped, achieving enhanced speed, convenience, and hygiene.

### BACKGROUND OF THE INVENTION

(a) Technical Field of the Invention

The present invention is generally related to bandages, and more particular to bandages for horse legs.

(b) Description of the Prior Art

A conventional horse bandage has a hook side of a Velcro or hook-and-loop fastener at an end, and a loop side of the Velcro or hook-and-loop fastener near-by.

When use the horse bandage, the horse bandage has to be unfolded and rolled from the end with the hook side configured into a roller with the loop side on an outer side. Then, to apply the horse bandage to a horse leg, the horse bandage is wrapped around the horse leg starting from an end without the hook and loop sides configured. After the wrapping is completed, the hook and loop sides are used to secure the wrapping. As described, the horse bandage has to be unfolded and rolled first, leading a lengthy operation.

On the other hand, to recollect the horse bandage, the hook and loop sides are detached, and the horse bandage is unwrapping from the horse leg. After that, the horse bandage is unfolded again to locate the end without the hook and loop sides, and then rolled again. After the horse bandage is turned into a roller, the roller is secured by the hook and loop sides. As described, to recollect the horse bandage, it has to be unfolded and rolled again, not only leading a lengthy operation, but also increasing the chance of contamination to the horse bandage.

### SUMMARY OF THE INVENTION

A major objective of the present invention is to provide a horse bandage that can be directly applied to a horse leg from a roller of the horse bandage, and re-collected into a roller as the horse bandage is simultaneously unwrapped from the horse leg. Then, a bridge element is applied to secure the wrapping or the rolling of the horse bandage, achieving enhanced speed and convenience, and reduced chance of contamination.

To achieve the above objective, the horse bandage contains an elongated main piece, a first fastening element configured at a first end of the main piece, and covering the first end's two major sides, a second fastening element configured at a second end of the main piece covering the second end's two major sides, a third fastening element configured on a major side of the main piece adjacent to the first fastening element, a fourth fastening element configured on a major side of the main piece adjacent to the second fastening element; and a bridge element to be positioned between and joined to the first and third fastening elements, or between and to the second and fourth elements.

In an embodiment, the main piece is made of a soft fabric.

In an embodiment, each of the first, second, third and fourth fastening elements provides a loop side of a hook-and-loop fastener, and the bridge element provides a hook side of the hook-and-loop fastener.

In an embodiment, the bridge element provides a hook side of a hook-and-loop fastener, and each of the first, second, third and fourth fastening elements are made of a fabric capable of being fastened by the bridge element.

In an embodiment, the third and fourth fastening elements are on a same major side of the main piece.

In an embodiment, the first and second fastening elements are perpendicular to the third and fourth fastening elements, respectively.

In an embodiment, the bridge element contains a first connection section and a second connection section. The first connection section is for joining to the first or second fastening element, and the second connection section is for joining to the third or fourth element.

In an embodiment, the first and second connection elements are perpendicular to each other.

In an embodiment, the horse bandage contains an additional set of a third fastening element and a fourth fastening element configured at another major side of the main piece located correspondingly to the original third and fourth fastening elements.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a horse bandage according to an embodiment of the present invention.

FIG. 2 is a perspective break-down diagram showing the horse bandage of FIG. 1.

FIG. 3 is a schematic profile diagram of the horse bandage of FIG. 1.

FIG. 4 is a perspective diagram showing the horse bandage of FIG. 1 as it is rolled into a roller.

FIG. 5 is a perspective diagram showing the horse bandage of FIG. 4 after rolling.

FIG. 6 is a schematic profile diagram of a horse bandage according to another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

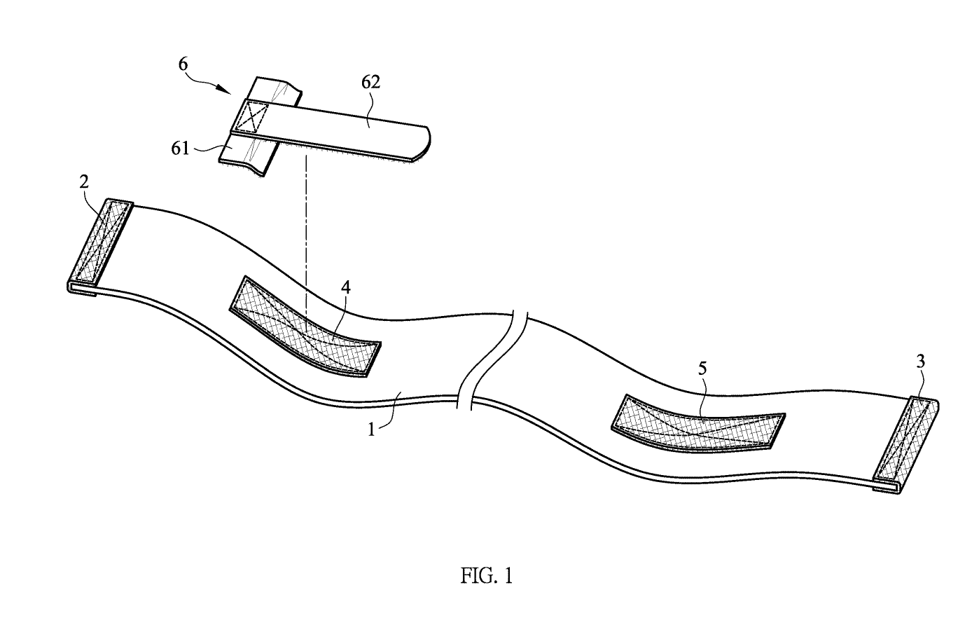

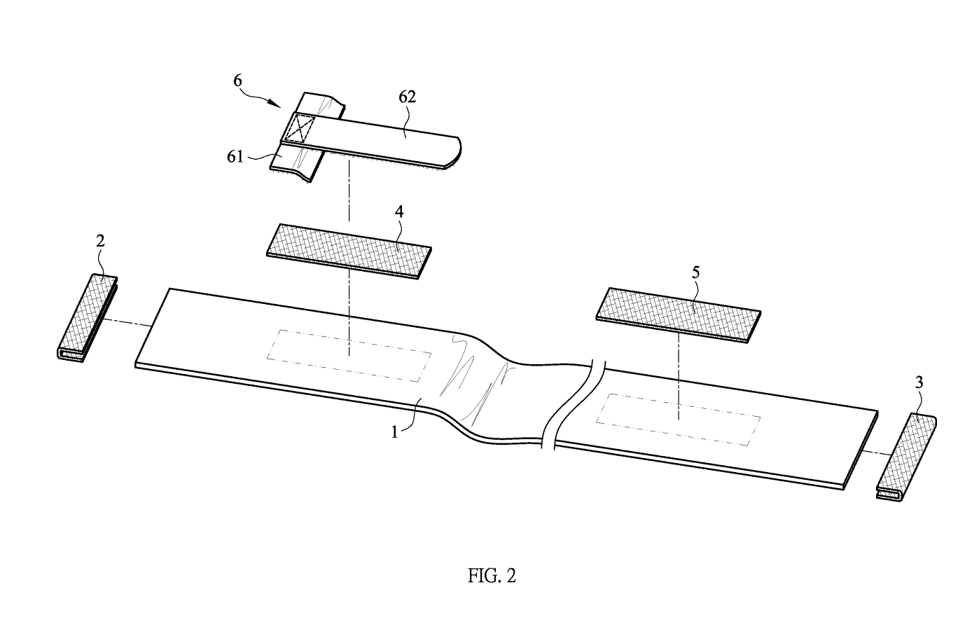

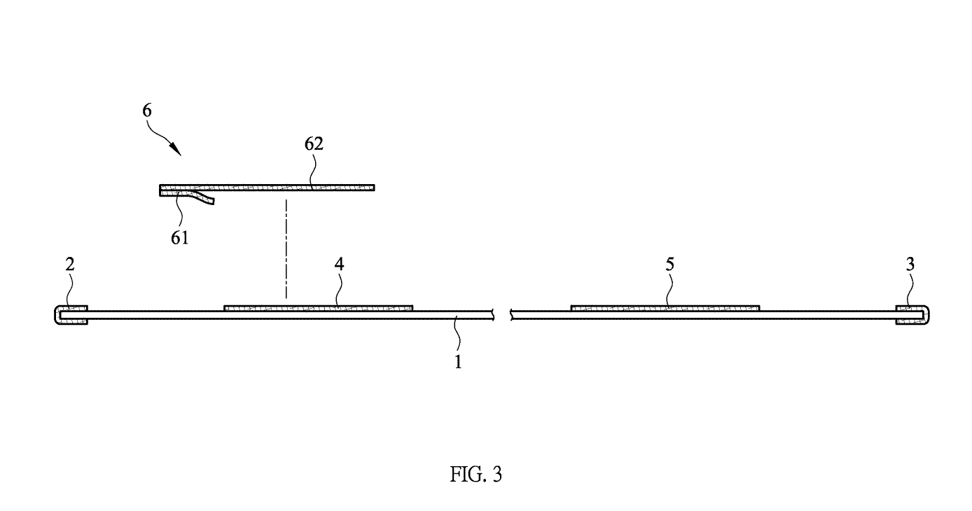

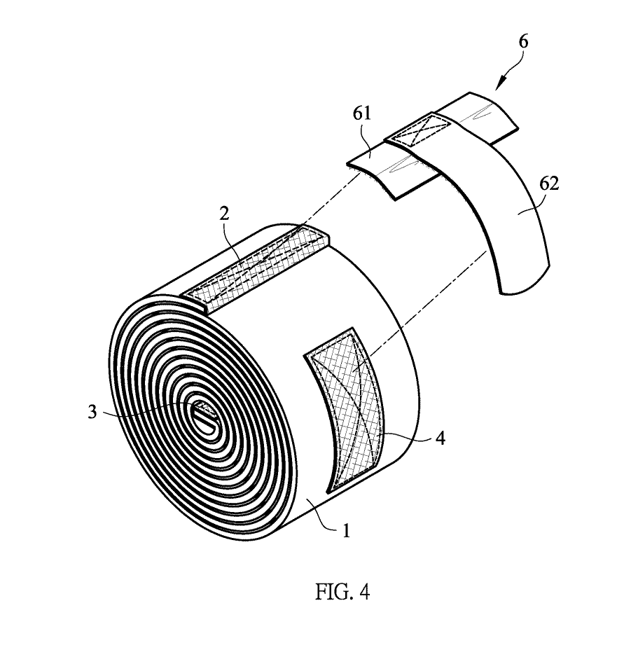

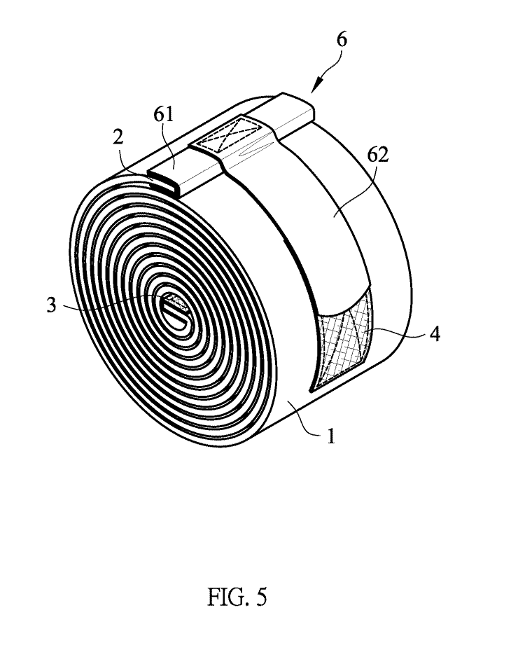

As illustrated in FIGS. 1 to 5, a horse bandage according to an embodiment of the present invention contains an elongated main piece 1, a first fastening element 2, a second fastening element 3, a third fastening element 4, a fourth fastening element 5, and a bridge element 6.

The main piece 1 is made of a soft fabric.

The first fastening element 2 is configured at a first end of the main piece 1 and covers the first end's two major sides.

The second fastening element 3 is configured at a second end of the main piece 1 and covers the second end's two major sides.

The third fastening element 4 is configured on a first major side of the main piece 1 adjacent to the first fastening element 2.

The fourth fastening element 5 is configured also on the first major side of the main piece 1 but adjacent to the second fastening element 3. As described, the third and fourth fastening elements 4 and 5 are on the same major side of the main piece 1, and the first and second fastening elements 2 and 3 are perpendicular to the third and fourth fastening elements 4 and 5, respectively.

The bridge element 6 is positioned either between the first and third fastening elements 2 and 4, or between the second and fourth elements 3 and 5. The bridge element 6 contains a first connection section 61 and a second connection section 62 perpendicular to the first connection section 61. The first connection section 61 is for joining to the first or second fastening element 2 or 3, whereas the second connection section 62 is for joining to the third or fourth element 4 or 5.

The first and second fastening elements 2 and 3, and the third and fourth fastening elements 4 and 5 are the loop sides of Velcro or hook-and-loop fasteners. The first and second connection sections 61 and 62, on the other hand, are the hook sides of Velcro or hook-and-loop fasteners. In an alternative embodiment, the first and second fastening elements 2 and 3, and the third and fourth fastening elements 4 and 5 can also be fabrics that can be fastened by the hooks of the bridge element 6.

To apply the horse bandage to a horse's leg, the bridge element 6 on a roller of the horse bandage is detached and removed from the first and third fastening elements 2 and 4 (or from the second and fourth fastening elements 3 and 5). Then, without unrolling the main piece 1, the roller of the main piece 1 is directly applied to the horse leg, staring from a loose end of the roller where the first or second fastening element 2 or 3 is located. As the main piece 1 is wrapped around the horse leg and after the second and fourth fastening elements 3 and 5 (or the first and third fastening elements 2 and 4) at the other end of the roller are exposed on an outside of the main piece 1, the bridge element 6 is applied therebetween to lock the wrapped main piece 1. As the roller of main piece 1 is not required to unroll first, the application of the horse bandage is faster and more convenient.

To remove the horse bandage from the horse leg, the bridge element 6 is detached and removed from the main piece 1 first. Then as the main piece 1 is unwrapped from the horse leg, it is rolled and collected simultaneously. After the main piece 1 turns into a roller again, the bridge element 6 is re-applied to the first and third fastening elements 2 and 4 (or the second and fourth fastening elements 3 and 5). As there is no need to completely un-rolled the main piece 1, the chance of contamination is reduced. The recollection of the horse bandage is again faster and more convenient.

Similarly, to clean the horse bandage, all is required is to remove the bridge element 6. As the bridge element 6, which has the hooks, is not cleaned together, the main piece 1 is prevented from being scratched. After cleaning, the main piece 1 can be rolled starting from any end with either the first fastening element 2 or the second fastening element 3 is configured. Again, after the main piece 1 is turned into a roller, the bridge element 6 is applied to the exposed first and third fastening elements 2 and 4 (or the second and fourth fastening elements 3 and 5) to secure the roller.

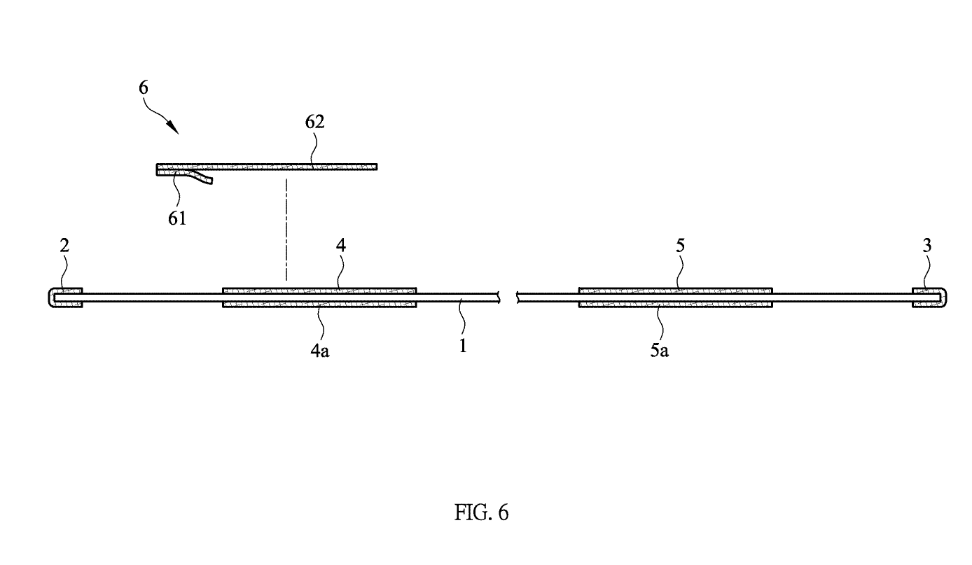

As shown in FIG. 6, a horse bandage according to another embodiment of the present invention has an additional set of the third and fourth fastening elements 4a and 5a configured at another major side of the main piece 1 located correspondingly to the original set of the third and fourth fastening elements 4 and 5.

In the present embodiment, since the main piece 1 now has the third and fourth fastening elements 4, 4a and 5, 5a on both major sides, the horse bandage can be applied to a horse leg without worrying about which major side is the outer side. After the second and fourth fastening elements 3 and 5 (or 5a) (or the first and third fastening elements 2 and 4 (or 4a)) are exposed, the bridge element 6 is applied therebetween to lock the wrapped main piece 1. Similarly, when the main piece 1 is unwrapped from the horse leg and is rolled and simultaneously, the orientation of the main piece 1 is not an issue. After the main piece 1 turns into a roller again, the bridge element 6 is re-applied to the first and third fastening elements 2 and 4 (or 4a) (or the second and fourth fastening elements 3 and 5 (or 5a)).

As described above, the horse bandage of the present invention can be directly applied to a horse leg from a roller of the horse bandage, and re-collected into a roller as the horse bandage is simultaneously unwrapped from the horse leg. Then, the bridge element is applied to secure the wrapping or the rolling of the horse bandage with enhanced speed and convenience, and reduced chance of contamination.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A horse bandage comprising:
an elongated main piece;
a first fastening element configured at a first end of the main piece and covering the first end's two major sides;
a second fastening element configured at a second end of the main piece covering the second end's two major sides;
a third fastening element configured on a major side of the main piece adjacent to the first fastening element;
a fourth fastening element configured on a major side of the main piece adjacent to the second fastening element; and
a bridge element to be positioned between and joined to the first and third fastening elements, or between and to the second and fourth elements.

2. The horse bandage according to claim 1, wherein the main piece is made of a soft fabric.

3. The horse bandage according to claim 1, wherein each of the first, second, third and fourth fastening elements provides a loop side of a hook-and-loop fastener; and the bridge element provides a hook side of the hook-and-loop fastener.

4. The horse bandage according to claim 1, wherein the bridge element provides a hook side of a hook-and-loop fastener; and each of the first, second, third and fourth fastening elements are made of a fabric capable of being fastened by the bridge element.

5. The horse bandage according to claim 1, wherein the third and fourth fastening elements are on a same major side of the main piece.

6. The horse bandage according to claim 1, wherein the first and second fastening elements are perpendicular to the third and fourth fastening elements, respectively.

7. The horse bandage according to claim 1, wherein the bridge element comprises a first connection section and a second connection section; the first connection section is for joining to the first or second fastening element; and the second connection section is for joining to the third or fourth element.

8. The horse bandage according to claim 7, wherein the first and second connection elements are perpendicular to each other.

9. The horse bandage according to claim 1, comprising an additional set of a third fastening element and a fourth fastening element configured at another major side of the main piece located correspondingly to the original third and fourth fastening elements.
